(19) United States
(12) Patent Application Publication
(10) Pub. No.: US 2012/0233917 A1
(43) Pub. Date: Sep. 20, 2012

(54) POLE PLANTER

(76) Inventor: Laura A. Sovey-Strah, Broadview Heights, OH (US)

(21) Appl. No.: 13/419,722

(22) Filed: Mar. 14, 2012

Related U.S. Application Data
(60) Provisional application No. 61/452,241, filed on Mar. 14, 2011.

(51) Int. Cl. A01G 9/02; B23P 17/00; B23P 11/00

(52) U.S. Cl. 47/66.3; 29/428; 29/525.08

(57) ABSTRACT

A pole planter assembly to be secured about a pole. The pole planter includes first and second independent chambers pivotally connected for growing plants. Each of the first and second chambers have wall sections with at least one inward indented surface and at least one outward projecting surface, and the wall sections of the first and second chambers are arranged whereby the at least one outward projecting surface of the wall section of the first chamber is arranged to fit within the corresponding at least one inward indented surface of the wall section of the second chamber to secure the first and second two chambers together. Each of the wall sections have concave surfaces to form a hollow shaped opening through the planter assembly when the first and second chambers are secured together to receive a pole.

### CROSS-REFERENCE TO RELATED APPLICATIONS

This application claims the benefit of U.S. Provisional Patent Application No. 61/452,241 filed on Mar. 14, 2011, which is incorporated herein by reference.

### TECHNICAL FIELD OF THE INVENTION

The present invention relates generally to a pole planter assembly to be secured about a pole. More specifically, the present invention relates to a pole planter including two self-contained, independent chambers that can each individually house plants or flowers. The two chambers are pivotally connected to complete the pole planter assembly about a pole.

### BACKGROUND OF THE INVENTION

Container gardening or planting has been well known in the gardening arts for literally centuries, with surviving examples being known from, for example, the Roman, Greek and Sumerian periods. Stated simply, container gardening is the growing of plants in a body of soil contained in a container which may, for example, be pottery, terra cotta, cement, stone, wood, plastic, and so on and which may be located either indoors or outdoors.

The sole requirements are that the containers be capable of containing and supporting the soil or other growing medium and that the containers be capable of retaining the desired degree or content of moisture for a sufficient period, which will depend on the requirements of the plants growing within the container and the growing environment and conditions. One difficulty associated with planters is the ability to situate them on a pole. Further, people often wish to secure a planter about a umbrella. The present invention seeks to alleviate these issues.

### SUMMARY OF THE INVENTION

According to an embodiment of the present invention, a pole planter assembly to be secured about a pole. The pole planter includes first and second independent chambers pivotally connected for growing plants. Each of the first and second chambers have wall sections with at least one inward indented surface and at least one outward projecting surface, and the wall sections of the first and second chambers are arranged whereby the at least one outward projecting surface of the wall section of the first chamber is arranged to fit within the corresponding at least one inward indented surface of the wall section of the second chamber to secure the first and second two chambers together. Each of the wall sections have concave surfaces to form a hollow shaped opening through the planter assembly when the first and second chambers are secured together to receive a pole.

According to another embodiment of the present invention, a method of securing a pole planter assembly about a pole. The method includes pivotally connecting first and second independent chambers for growing plants. The method further includes providing each of the first and second chambers with wall sections with at least one inward indented surface and at least one outward projecting surface, and arranging the wall sections of the first and second chambers whereby the at least one outward projecting surface of the wall section of the first chamber fits within the corresponding at least one inward indented surface of the wall section of the second chamber to secure the first and second two chambers together. Finally, the method includes forming a hollow shaped opening through the planter assembly when the first and second chambers are secured together to receive a pole.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three-dimensional view of the pole planter assembly, in accordance with the present invention.

FIG. 2 is a front, three-dimensional view of an alternative embodiment of the pole planter assembly, in accordance with the present invention.

FIG. 3 is an exploded view of the elements of the pole planter assembly, in accordance with the present invention.

FIG. 4 is a three-dimensional, bottom view of the pole planter assembly, in accordance with the present invention.

FIG. 5 is a side view of a pole with a clamp to be used in conjunction with the pole planter assembly, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

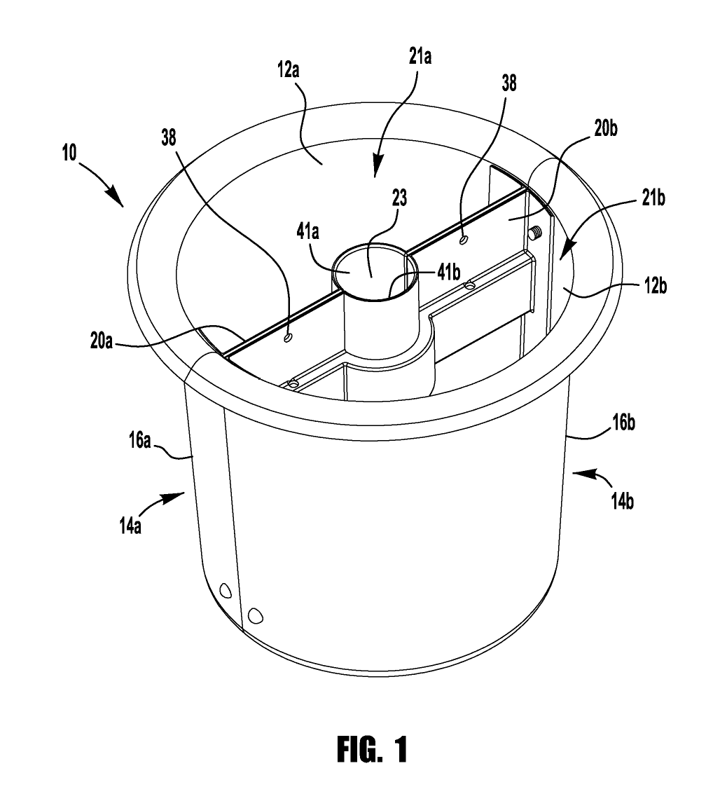

FIG. 1 illustrates a front, three-dimensional view of the pole planter assembly 10. Pole planter assembly 10 is designed to grow plants and flowers in the planter assembly that can be secured about a pole, such as an umbrella or lamp pole. In general terms, pole planter assembly 10 consists of two self-contained, independent chambers 12a and 12b that can each individually house plants or flowers. The two chambers 12a and 12b can be easily joined together to complete the pole planter assembly 10.

Pole planter assembly 10 can be constructed of an appropriate material, such as, but not limited to a lightweight plastic polymer. While in one embodiment, pole planter assembly 10 will be a black color, allowing it to act as a backdrop to enhance the beauty and colors of the flower and plants placed inside, it is within the terms of the invention for the assembly 10 to be of any desired color. Pole planter assembly 10 can be constructed of a wide range of dimensions. For example, the height may be between about 5 inches (″) and 24″, and the diameter of the rim may be between about 6″ and 24″, however any desired dimensions may be used. In a typical embodiment, pole planter assembly 10 has a height of about 7″ and a diameter of about 11″. While pole planter 10 is designed to mount onto a pole with a diameter of about 3″ or less, it is within the terms of the invention to construct the pole planter to mount onto poles having a diameter of more than 3″.

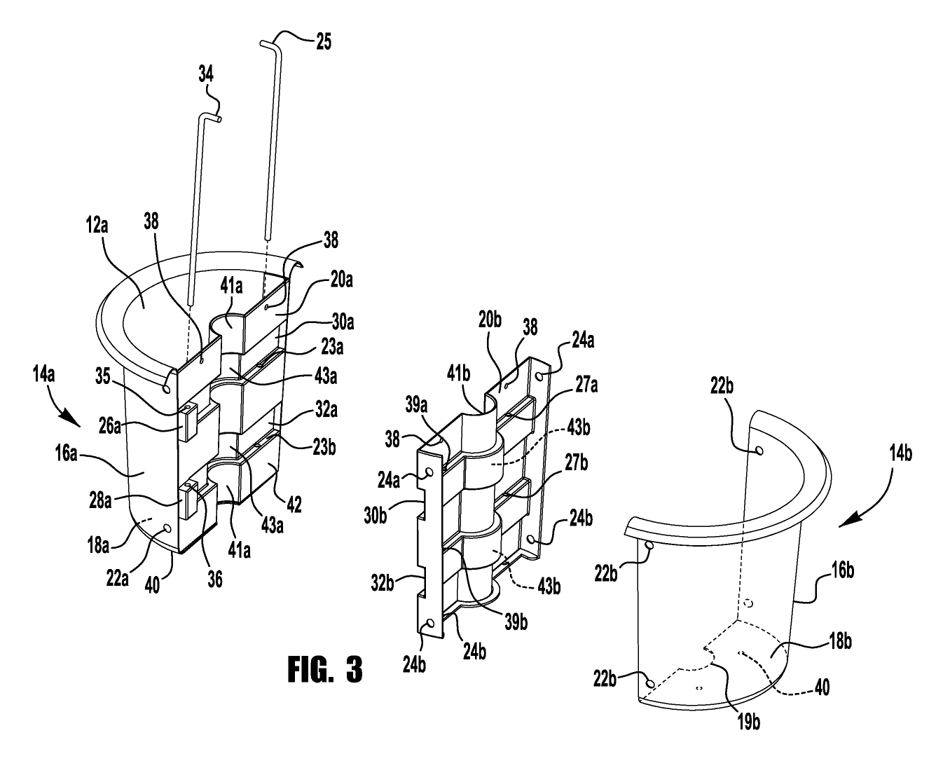

Although pole planter assembly 10 has the appearance of a one piece, substantially cylindrical planter, it is actually constructed of two substantially identical, self-contained half cylindrically shaped chambers 12a and 12b that are joined together. While, the planter assembly is shown as being constructed as having a cylindrical shape, it is within the terms of the invention for the planter assembly to have a frusto-conical shape (not shown) of two substantially identical, self-contained half frusto-conical shaped that are joined together. Chambers 12a and 12b are each capable of independently housing and growing plants and flowers. Each chamber 12a and 12b is designed to allow water used to for the plants to drain out of the 12a and 12b through drain holes 40 in the bottom (as seen in FIG. 3). This precludes plants from sitting in standing water due to rain or over watering without losing large amounts of soil. It is within the terms of invention to have additional or alternative means of draining water from chambers 12a and 12b.

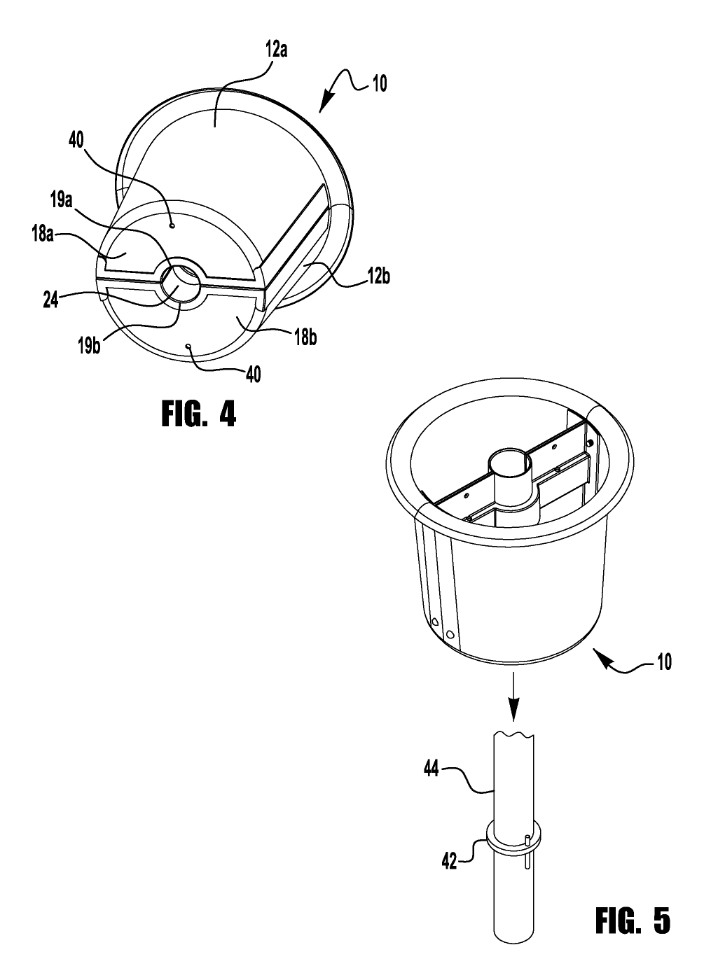

Each self-contained half cylindrically shaped chamber 12a and 12b, has two substantially identical half-cylindrical sections, 14a and 14b. Sections 14a and 14b each have a sidewall 16a and 16b, with an attached floor portion 18a and 18b, as seen in FIGS. 3 and 4. Floor portion 18a and 18b each have a semicircular opening 19a and 19b, respectively, which face each other and form a hollow, cylindrically shaped opening 23 extending through the pole planter assembly 10 when the two substantially identical half-cylindrical sections, 14a and 14b are abutted and secured with each other to form the pole planter assembly 10.

Substantially identical wall sections 20a and 20b are mounted to the half-cylindrical sections, 14a and 14b, as shown in FIG. 3, to form the enclosed chambers 12a and 12b, each with an open top end 21a and 21b from which the plants and flowers can project out of the half-cylindrical sections, 14a and 14b. Wall sections 20a and 20b have upper, outward projecting surfaces 26a and 26b (not shown), respectively, and lower, outward projecting surfaces 28a and 28b (not shown), respectively, disposed adjacent the sidewalls 16a and 16b, respectively. Although the illustrated embodiment has removable wall sections 20a and 20b, it is within the terms of the invention that the half-cylindrical sections, 14a and 14b, are each one, unified piece.

Wall sections 20a and 20b further have upper, inward indented surfaces 30a and 30b, respectively, and lower, inward indented surfaces 32a and 32b, respectively disposed adjacent the sidewalls 16a and 16b, respectively. When the half-cylindrical sections, 14a and 14b, are secured together, the upper and lower, outward projecting surfaces 26a and 28a, respectively, of section 14a fit within the inward indented surfaces 30b and 32b of section 14b and the upper and lower, outward projecting surfaces 28a and 28b (not shown but identical to outward projecting surfaces 26a and 28a), respectively, of section 14b fit within the inward indented surfaces 30a and 32a of section 14a. Although this is one manner of snapping half-cylindrical sections, 14a and 14b together, it is within the terms of the invention to secure the cylindrical sections, 14a and 14b together using other structure and methods.

Wall sections 20a and 20b each have spaced, concave surfaces 41a and 41b, respectively, that extend about 180° and form the hollow, cylindrically shaped opening 23 through planter 10. Between each of the concave surfaces 41a and 41b are inward indented concave surfaces 43a and 43b. However, it is within the terms of the invention for the concave surfaces 41a and 41b to form one elongated surface through planter 10.

To secure wall sections 20a and 20b, there are a plurality of screw holes 22a and 22b spaced along the edges of sections 14a and 14b, respectively, which correspond to matching screw holes 24a and 24b about the edges of wall sections 20a and 20b, respectively. Once wall portions 20a and 20b are secured in place by any means such as screws through the matching screw holes, the two enclosed chambers 12a and 12b are formed. While the chambers 12a and 12b are described as being constructed of several elements that can be screwed together, it is within the terms of the invention to form each of the chambers from as a single structure or with more elements as needed.

As illustrated in FIG. 1, once chambers 12a and 12b have been assembled, the two are joined together to form the complete pole planter assembly 10, which can then be secured about a pole as shown in FIG. 5. To secure the two chambers 12a and 12b together, a pin 25, as seen in FIG. 3, can be inserted through an upper hole 23a and a lower hole 23b on wall section 20a and through corresponding holes in outward projecting surfaces 28a and 28b of wall section 20b. The pin 25 forms a hinge so that the two chambers 12a and 12b can pivot opened about pin 25 and then close with respect to each other.

When the chambers 12a and 12b are hinged together and then pressed against each other such that wall portions 20a and 20b are pressed against each other, the upper and lower, outward projecting surfaces 26a and 28a, respectively, of section 14a fit within the inward indented surfaces 30b and 32b of section 14b and the upper and lower, outward projecting surfaces 26b and 28b (not shown), respectively, of section 14b fit within the inward indented surfaces 30a and 32a of section 14a. When the outward projecting surfaces are disposed within the inward indented surfaces, the two chambers 12a and 12b can be secured to each other by friction, and hold the pole planter assembly 10, as a unit, in place such as on a pole.

Once chambers 12a and 12b are attached and abutted against each other, a pin 34, as shown in FIG. 3, is inserted through an upper hole 35 and a lower hole 36 through outward projecting surfaces 26a and 28a, respectively, of section 14a and through an upper hole 39a and a lower hole 39b in wall section 20b. While pin 34 completes the connection of the two chambers 12a and 12b, it can also forms a hinge so that the two chambers 12a and 12b can pivot opened and closed about pin 34 and enable the two chambers 12a and 12b to pivot open and closed with respect to each other once the pin 25 is removed.

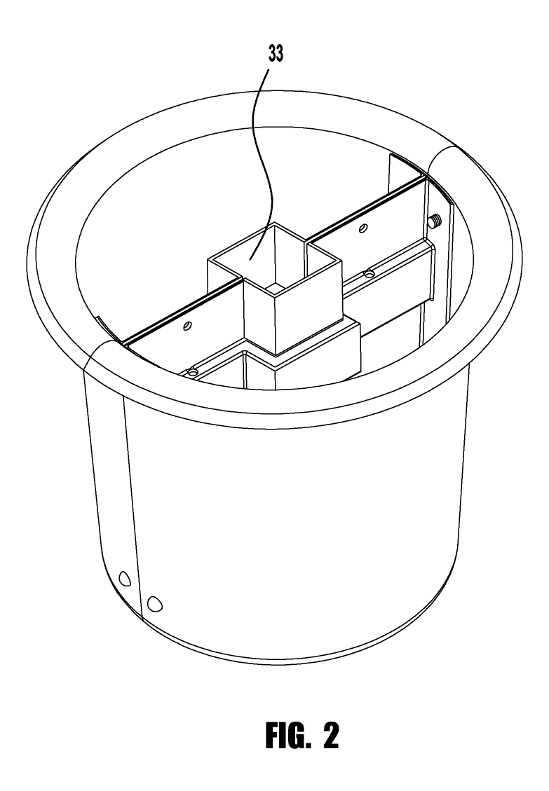

As illustrated in FIG. 2, pole planter assembly 10 may have an alternative embodiment in which the opening 33 extending through the planter between wall portions 20a and 20b is a square shape to accommodate a square pole or post of 4″ square or less. While pole planter 10 is designed to mount onto a pole or post of about 4″ square or less, it is within the terms of the invention to construct the pole planter to mount onto a pole or post of more than 4″ square. Further, pole planter assembly 10 can have a circular hole 23 or a square hole 33 or any other appropriate shaped opening there through to accommodate other potential pole shapes and sizes, such as flag poles, deck posts, mail boxes, and bird feeding systems.

Although not strictly necessary, there may be a clamp 42 on the pole 44 to further support pole planter assembly 10, as seen in FIG. 5.

Alternatively, there may be hooks attached to pole planter assembly 10 through S hook holes 38, which then may hook on to the pole itself.

According to an embodiment of the invention a method of securing a pole planter assembly about a pole comprises planting each of the first and second independent chambers 12a and 12b with plants. The first and second chambers 12a and 12b each have wall sections 20a and 20b, respectively, with at least one inward indented surface 30a and 30b, respectively, and at least one outward projecting surface 26a and 26b, respectively. The wall sections 20a and 20b of the first and second chambers 12a and 12b are arranged so that at least one outward projecting surface of the wall section of the first chamber fits within the corresponding at least one inward indented surface of the wall section of the second chamber to secure the first and second two chambers together. A hollow shaped opening 23 is formed through the planter assembly 10 when the first and second chambers are secured together to receive a pole 44.

The method of securing a pole planter assembly 10 also includes providing each of the wall sections of the first and second chambers with two inward indented surfaces and two outward projecting surfaces. The wall sections of the first and second chambers are arranged whereby the two outward projecting surfaces of the wall section of the first chamber fit within the corresponding two inward indented surfaces of the wall section of the second chamber and the two outward projecting surfaces of the wall section of the second chamber fit within the corresponding two inward indented surfaces of the wall section of the first chamber to secure the first and second two chambers together.

The method of securing a pole planter assembly 10 also includes pivotally connecting the wall sections of the first and second chambers to each other along a first side of each of the wall sections to form the hollow shaped opening through the planter assembly about the pole. Also, the wall sections of the first and second chambers are connected to each other along a second side of each of the wall sections to form the hollow shaped opening through the planter assembly about the pole. The wall sections of the first and second chambers can be secured to each other along the first and second sides of the wall sections with removable pins.

The method of securing a pole planter assembly also can include securing a freestanding clamp to the pole at a desired location and supporting the pole planter assembly on the pole with the freestanding clamp.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A pole planter assembly to be secured about a pole, comprising:
first and second independent chambers pivotally connected for growing plants;
each of the first and second chambers having wall sections with at least one inward indented surface and at least one outward projecting surface, and the wall sections of the first and second chambers being arranged whereby the at least one outward projecting surface of the wall section of the first chamber being arranged to fit within the corresponding at least one inward indented surface of the wall section of the second chamber to secure the first and second two chambers together; and
each of the wall sections have concave surfaces to form a hollow shaped opening through the planter assembly when the first and second chambers are secured together to receive a pole.

2. The pole planter assembly of claim 1 wherein:
each of the wall sections of the first and second chambers have two inward indented surfaces and two outward projecting surfaces; and
the wall sections of the first and second chambers being arranged whereby the two outward projecting surfaces of the wall section of the first chamber are arranged to fit within the corresponding two inward indented surfaces of the wall section of the second chamber and the two outward projecting surfaces of the wall section of the second chamber are arranged to fit within the corresponding two inward indented surfaces of the wall section of the first chamber to secure the first and second two chambers together.

3. The pole planter assembly of claim 2 wherein the wall sections of the first and second chambers are pivotally connected to each other along a first side of each of the wall sections.

4. The pole planter assembly of claim 3 wherein the wall sections of the first and second chambers are pivotally connected to each other along a second side of each of the wall sections.

5. The pole planter assembly of claim 1 wherein the hollow shaped opening through the planter has a cylindrical shape.

6. The pole planter assembly of claim 1 wherein the hollow shaped opening through the planter has a square shape.

7. The pole planter assembly of claim 3 wherein the first and second chambers are substantially identically shaped half cylindrically shaped chambers.

8. The pole planter assembly of claim 7 wherein the first and second chambers each include a floor portion.

9. The pole planter assembly of claim 8 wherein each floor section of the first and second chambers has a semicircular opening which face each other and form a circular opening when the two substantially identical half-cylindrically shaped chambers are engaged with each other.

10. The pole planter assembly of claim 9 wherein each floor section includes drain holes there through.

11. The pole planter assembly of claim 8 wherein each of the first and second independent chambers has a frusto-conical shape.

12. The pole planter assembly of claim 8 wherein a freestanding clamp is adapted to be secured to the pole at a desired location disposed underneath the floor portions of the first and second chambers to support the pole planter assembly.

13. The pole planter assembly of claim 8 wherein the wall sections of the first and second chambers are pivotally connected to each other along a first side of each of the wall sections with a pin inserted through an upper hole and a lower hole on the wall section of the first chamber and through corresponding holes in the wall section of the second chamber so that the first and second chambers can pivot opened and closed with respect to each other.

14. The pole planter assembly of claim 13 wherein the wall sections of the first and second chambers are pivotally connected to each other along a second side of each of the wall sections with a pin inserted through an upper hole and a lower hole on the wall section of the first chamber and through corresponding holes in the wall section of the second chamber so that the first and second chambers can pivot opened and closed with respect to each other.

15. A method of securing a pole planter assembly about a pole, comprising:
pivotally connecting first and second independent chambers for growing plants;
providing each of the first and second chambers with wall sections with at least one inward indented surface and at least one outward projecting surface;
arranging the wall sections of the first and second chambers whereby the at least one outward projecting surface of the wall section of the first chamber fits within the corresponding at least one inward indented surface of the wall section of the second chamber to secure the first and second two chambers together; and
forming a hollow shaped opening through the planter assembly when the first and second chambers are secured together to receive a pole.

16. The method of securing a pole planter assembly of claim 15 including:
providing each of the wall sections of the first and second chambers with two inward indented surfaces and two outward projecting surfaces; and
arranging the wall sections of the first and second chambers whereby the two outward projecting surfaces of the wall section of the first chamber fit within the corresponding two inward indented surfaces of the wall section of the second chamber and the two outward projecting surfaces of the wall section of the second chamber fit within the corresponding two inward indented surfaces of the wall section of the first chamber to secure the first and second two chambers together.

17. The method of securing a pole planter assembly of claim 16 including:
pivotally connecting the wall sections of the first and second chambers to each other along a first side of each of the wall sections to form the hollow shaped opening through the planter assembly about the pole.

18. The method of securing a pole planter assembly of claim 17 including:
connecting the wall sections of the first and second chambers to each other along a second side of each of the wall sections to form the hollow shaped opening through the planter assembly about the pole.

19. The method of securing a pole planter assembly of claim 18 including securing the wall sections of the first and second chambers to each other along the first and second sides of the wall sections with removable pins.

20. The method of securing a pole planter assembly of claim 19 including:
securing a freestanding clamp to the pole at a desired location; and
supporting the pole planter assembly on the pole with the freestanding clamp.
